(19) United States
(12) Patent Application Publication
(10) Pub. No.: US 2026/0100852 A1
(43) Pub. Date: Apr. 9, 2026

(54) Systems and Methods for Vehicle Charging Using Encrypted Certificates

(71) Applicant: Daimler Truck AG, Leinfelden-Echterdingen (DE)

(72) Inventors: Sashank Mani Vedula, Portland, OR (US); Ashish Baban Bansod, Portland, OR (US); Sathish Vijayaraghavan, Portland, OR (US); Torsten Lehmann, Stuttgart (DE)

(21) Appl. No.: 19/334,797

(22) Filed: Sep. 19, 2025

Related U.S. Application Data
(60) Provisional application No. 63/705,026, filed on Oct. 8, 2024.

(51) Int. Cl. H04L 9/32; H04L 9/08

(52) U.S. Cl. CPC H04L 9/3268; H04L 9/0861; H04L 2209/84

(57) ABSTRACT

The various implementations described herein include methods and devices for equipment authentication for electric vehicle charging. In one aspect, a method includes receiving a plurality of test results for a vehicle charging component and generating an encryption key, a corresponding decryption key, and an encrypted certificate for the vehicle charging component. The method also includes providing the encrypted certificate and the decryption key to the vehicle charging component. In another aspect, a method performed at a vehicle charging component includes detecting an electrical connection at a charging port of the vehicle charging component, determining that the electrical connection corresponds to a request to begin a charging process with a charging partner, and transmitting an encrypted certificate and a decryption key to the charging partner. The encrypted certificate includes encrypted test results for the vehicle charging component, and the decryption key can be used to decrypt the encrypted certificate.

### RELATED APPLICATIONS

This application claims the benefit of and priority to U.S. Provisional Patent Application No. 63/705,026 , filed Oct. 8, 2024, entitled “Systems and Methods for Vehicle Charging Using Encrypted Certificates,” which is incorporated by reference herein in its entirety.

### TECHNICAL FIELD

The disclosed implementations relate generally to equipment authentication and more specifically to systems and methods of using encrypted certificates to authenticate vehicle charging equipment.

### BACKGROUND

Electrical vehicles (EVs) are becoming more prevalent as a mode of transportation. As the infrastructure to support the operation of EVs grows with the popularity of EVs, more options and accessories will become widely available for charging EVs. Presently, there is no method for authenticating equipment used in EV charging, which leaves EVs and their users at risk of using equipment that has not passed certain tests or does not meet certain standards (such as safety tests, performance tests, and/or industry standards).

### SUMMARY

Disclosed implementations provide authenticated test results for charging equipment to ensure the safety of EVs and their users.

As the popularity of EVs grows, so does the demand for equipment and accessories for charging EVs. As the number of manufacturers of EVs and charging equipment (such as EVs, public charging stations, home charging stations, vehicle-to-vehicle charging solutions, and extended battery packs) increases, verification that EVs and charging equipment meet safety and industry standards before engaging in a charge transfer process can be vital for the safety and health of EVs and their users, and is much needed in a currently unregulated field. Systems and methods for authenticating and verifying the safety and performance of charging equipment and EVs are provided here, using encrypted certificates that can be exchanged between devices (including EVs and charging equipment) to provide authenticated test results to each device before beginning a charge transfer process.

In accordance with some implementations, a method includes receiving a plurality of test results for a vehicle charging component. Each test result corresponds to a respective predefined test of the vehicle charging component. The method also includes generating an encryption key and a corresponding decryption key, and generating an encrypted certificate for the vehicle charging component according to the encryption key. The method further includes providing the encrypted certificate and the decryption key to the vehicle charging component.

In accordance with some implementations, a method includes detecting an electrical connection at a charging port of the vehicle charging component and determining that the electrical connection corresponds to a request to begin a charging process with a charging partner. In response to the determination that a charging process is requested, the method transmits a first encrypted certificate and a first decryption key to the charging partner. The first encrypted certificate includes encrypted test results for a plurality of predefined tests conducted for the vehicle charging component, and the first decryption key corresponds to the first encryption key used to encrypt the first encrypted certificate.

In accordance with some implementations, a vehicle charging component includes a charging port configured to couple with a charging accessory for exchange of electrical charge with a charging partner and a non-transitory computer-readable storage medium configured to store an encrypted certificate and a decryption key corresponding to an encryption key used to encrypt the encrypted certificate. The encrypted certificate includes a plurality of encrypted test results for a plurality of predefined tests conducted on the vehicle charging component. A first test result of the plurality of test results indicates whether the charging component passed or failed a first predefined test.

In some implementations, a computing device includes one or more processors, memory, and one or more programs stored in the memory. The programs are configured for execution by the one or more processors. The one or more programs include instructions for performing any of the methods described herein.

In some implementations, a non-transitory computer-readable storage medium stores one or more programs configured for execution by a computing device having one or more processors, memory, and a display. The one or more programs include instructions for performing any of the methods described herein.

Existing systems do not have any formal authority that can guarantee that the safety, specifications, and quality of an EV or charging equipment meet current standards. Currently, the safety and reliability of EV charging related equipment relies on an inherent trust between a consumer and the manufacturer of the EV or charging equipment since a certification authority (e.g., trusted authority) that enforces standards or verifies test results and specifications does not exist. Presently, OEMs can only provide charging recommendations (e.g., which chargers to use or where to charge) to users of EVs based on interoperability test results. They are unable to control or even identify what charger the EV user may choose to charge their EV. The growing network for EV chargers opens the possibility for chargers that do not follow safety standards. Additionally, the lack of charger identification presents a challenge to determine how well the chargers may perform. Furthermore, test results, when provided without encryption, are vulnerable to modification by outside or malicious actors. In various circumstances, the systems and methods of the present disclosure have the following advantages over current systems. First, in accordance with some implementations, the systems and methods described herein provide generation of encrypted certificates that include encrypted test results for an EV or a charging component. The encrypted certificate (and corresponding decryption key) can be exchanged between devices (e.g., between two charging partners during a charge transfer process, such as between an EV and charging equipment or between two EVs) to provide each charging partner with validated and authenticated test results, confirming the safety and compatibility between the two charging partners. The encryption ensures that test results cannot be tampered with after the encryption and thus, can be relied upon as a trusted source of test results coming from the original equipment manufacturer (OEM). Second, in accordance with some implementations, when the encryption certificate and corresponding decryption key are generated by a certification authority that oversees and enforces compliance to safety and industry standards, each charging partner can proceed in a charge transfer process with confidence in the safety and compatibility of the charge transfer process beyond an inherent trust that the equipment manufacturer has truthfully reported their test results. Currently, no degree of encryption for test results exists, and no certification authority exists to ensure that manufacturers in this field are in compliance with safety and industry standards. Thus, methods and systems are disclosed for authenticating charging components (including EVs and charging equipment). Such methods and systems may complement or replace conventional methods and systems within the EV field, which currently faces no official regulation.

### BRIEF DESCRIPTION OF THE DRAWINGS

For a better understanding of the aforementioned systems and methods, as well as additional systems and methods that provide authentication or validation of vehicle charging equipment, reference should be made to the Description of Implementations below, in conjunction with the following drawings in which like reference numerals refer to corresponding parts throughout the figures.

FIG. 1 illustrates an example process of generating encrypted certificate(s) and decryption key(s) for authenticating vehicle charging equipment in accordance with some implementations.

FIG. 2 illustrates an example process for authenticating vehicle charging equipment in accordance with some implementations.

FIG. 3 is a block diagram of an example computing device in accordance with some implementations.

FIG. 4 is a block diagram of an example computing device in accordance with some implementations.

FIG. 5 provides a flowchart of a method for generating an encrypted certificate and decryption key for authenticating vehicle charging equipment in accordance with some implementations.

FIG. 6A-6D provide a flowchart of a method for authenticating vehicle charging equipment in accordance with some implementations.

Reference will now be made to implementations, examples of which are illustrated in the accompanying drawings. In the following description, numerous specific details are set forth in order to provide a thorough understanding of the present invention. However, it will be apparent to one of ordinary skill in the art that the present invention may be practiced without requiring these specific details.

### DESCRIPTION OF IMPLEMENTATIONS

Systems and methods of the present disclosure allow test results to be authenticated, protected from tampering, and shared amongst devices (e.g., charging equipment, including EVs and charging accessories) to ensure that standards (e.g., safety tests, performance tests, industry standards, and international standards) are met. In accordance with some implementations, the system includes a computer system associated with a manufacturer or a certification authority (e.g., a trusted authority) that can receive test results, encrypt the test results in the form of an encrypted certificate and corresponding decryption key, and provide the encrypted certificate and decryption key upon request. In accordance with some implementations, a charging component may request an encrypted certificate and corresponding decryption key from a charging partner prior to initiating a charge transfer process. Similarly, an encrypted certificate and corresponding decryption key for the charging component may be requested by a charging partner prior to initiating a charge transfer process. This system of providing authenticated and protected test results builds a foundation of trust and safety within the EV and EV-related industry.

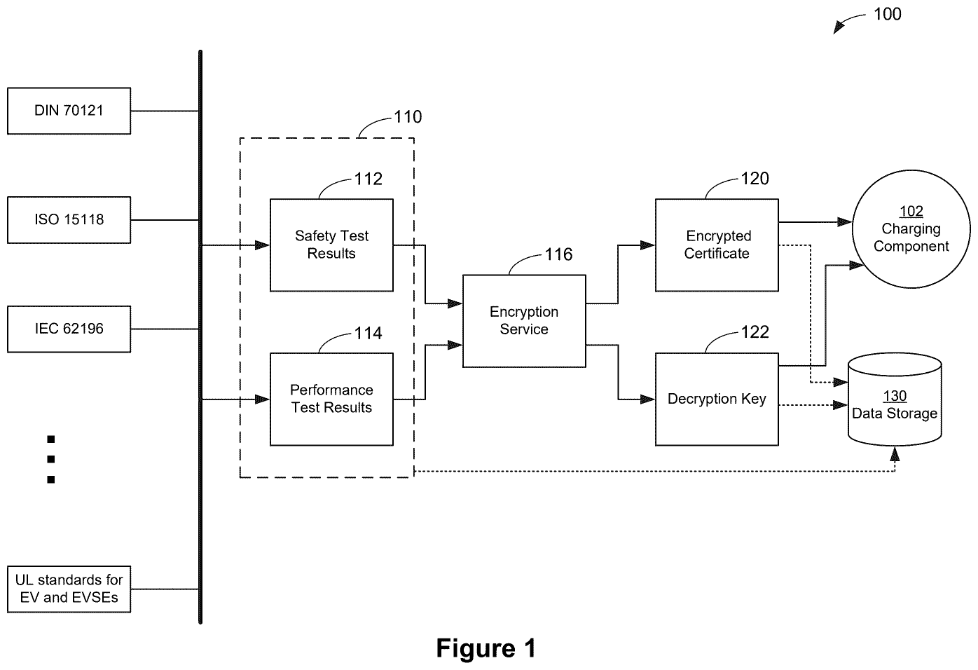

FIG. 1 illustrates an example process 100 of generating encrypted certificate(s) and decryption key(s) for authenticating vehicle charging equipment (also referred to herein as charging component(s)) in accordance with some implementations. The process 100 begins with receiving one or more test results 110 for a charging component 102. A charging component 102 refers to any component that is involved in a charging process (also referred to herein as a charge transfer process), including for example, EVs, charging cables, charging stations, and battery packs. In some implementations, testing is performed by a manufacturer (e.g., OEM) of the charging component 102. In some implementations, testing is performed by (a) a third party that may be paid by the manufacturer to conduct testing, or by (b) a third party that is part of an organization that oversees testing validation within the industry. In some implementations, the one or more test results 110 include results from tests (e.g., predefined tests) that are designed to ensure that the charging component 102 (e.g., product) meets industry standards (such as DIN 70121, and Underwriters Laboratories (UL) standards). In some implementations, the one or more test results 110 include safety test results 112 (e.g., results for safety-related tests). In some implementations, the one or more test results 110 include performance test results 114 (e.g., results for performance-related tests). For example, a charging component 102 may be an EV manufactured by Daimler. Test result(s) for the EV may be performed by Daimler, a certification authority, or third party (such as a testing company). For example, the one or more test results 110 may include results from a test to determine if a charge provider (e.g., a charger or a charge donor) complies with IEC61851-23 guidelines for responding to a disconnection on load. A charge provider that fails to reduce the current to less than 5 amperes within a timeframe of 30 milliseconds from the disconnection would fail this safety test (as it does not meet the IEC61851-23 guidelines). In another example, a test can be conducted to determine whether a charge provider (e.g., a charger or a charge donor) performs isolation monitoring during a charging process. In the case where an isolation fault occurs during the charging process, the charge provider is not monitoring the charging process, so a hazard could occur that leads to damage. Thus, a failed safety test would be reported on a certificate corresponding to this charge provider.

In some implementations, the process 100 is conducted by a manufacturer of the charging component. In some implementations, the process is conducted by a certification authority that is implemented to enforce compliance with standards and authenticate and verify that reported results are valid and truly in compliance.

Once the test(s) are conducted and the one or more test results 110 are received, the test results 110 are encrypted by an encryption service 116. In some implementations, the encryption service 116 is part of a service provided by a manufacturer of the charging component. In some implementations, the encryption service 116 is part of a service provided by a certification authority. In some implementations, the encryption service 116 is part of a service provided by a third party that is trusted by the manufacturer or a certification authority to perform the encryption. The encryption service 116 encrypts the one or more test results 110 for the charging component, thereby generating an encrypted certificate 120 for the charging component and a corresponding decryption key 122 that can be used to decrypt the encrypted certificate 120. In some implementations, the encrypted certificate 120 is an OEM-specific encrypted certificate. The encrypted certificate 120 and decryption key 122 are then provided to the charging component 102 for storage, so that if test results are requested (e.g., by a charging partner) from the charging component 102, the charging component 102 can provide the encrypted certificate 120 and the decryption key 122 to the requestor. In some implementations, the test result(s) 110, the encrypted certificate 120, and/or the decryption key 122 are stored in data storage 130. The data storage 130 may be data storage belonging to the encryption service 116, the manufacturer of the charging component 102, and/or the certification authority. For example, the test results 110 may be stored at a database 130 belonging to the certification authority and may be searchable by users. For instance, the manufacturer of an EV may be able to look up or request test results for a charging component 102 that is certified by the certification authority using, for example, a component ID corresponding to the charging component 102.

For example, when an EV is plugged into a charging station, the EV may request an encrypted certificate and decryption key for the charging station. Similarly, the charging station may request an encrypted certificate and decryption key for the EV. Once both parties (e.g., both the EV and charging station) have decrypted the encrypted certificate and confirmed that each party is satisfied with the reported test result(s) that are encrypted within the certificate, a charge transfer process can begin.

In some implementations, testing is conducted on one unit of the charging component 102 and the test result(s) 110 are considered to be valid for a plurality of other units of the same make and model. For example, a first unit of an EV that has a make and model of “2024 ASA” may undergo testing and the test result(s) from the first unit is considered valid for all other EVs that have the same make and model. Thus, the encrypted certificate 120 stored at a specific “2020 ASA” EV may include encrypted test results that were performed on a different unit (e.g., different EV) having the same make and model.

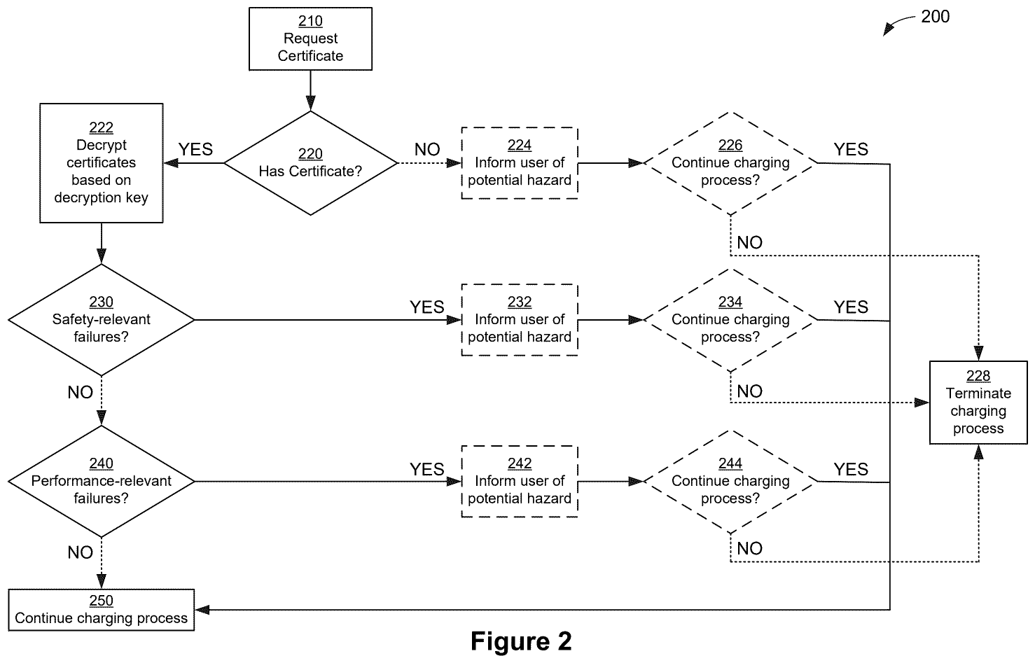

FIG. 2 illustrates an example process 200 for authenticating vehicle charging equipment in accordance with some implementations. The process 200 occurs during a charging process between two charging components (e.g., between an EV and a charger or between a charge donor and a charge acceptor). The process 200 may be conducted at a charging component 102 that can be either a charge donor and/or a charge acceptor. For example, the process 200 may be conducted at a charging station or by a charging accessory. In another example, the process 200 may be conducted at an EV.

The process 200 is conducted at a first charging component and begins with a request 210, from the first charging component to a second charging component, for a certificate (e.g., an encrypted certificate 120) corresponding to the second charging component. This may occur, for example, when the first and second charging components are about to initiate a charge transfer process, such as an EV plugging into a charging station or plugging an external battery source (e.g., extended battery pack or EV power bank) into an EV for charging. After receiving the request 210 for a certificate (e.g., the encrypted certificate 120), the first charging component determines (step 220) whether the second charging component has a certificate. In some implementations, when the second charging component does not have a certificate, the process is automatically terminated (step 228), and a charge transfer process cannot proceed between the two charging components. In some implementations, a user of the first charging component is informed (step 224) that the second charging component does not have a certificate. In some implementations, the first charging component prompts (226) the user to decide whether to continue the charging process. In such cases, a user can decide to continue the charge transfer process despite the second charging component not having a certificate.

In the case where the second charging component has a certificate and sends an encrypted certificate 120 and corresponding decryption key 122 to the first charging component, the first charging component decrypts (222) the encrypted certificate using the decryption key and determines (steps 230 and 240) whether the second charging component has any safety-relevant failures and/or any performance-relevant failures (e.g., whether the decrypted test results from the certificate 120 indicate failed test results that can affect the safety or performance of the second charging component). In some implementations, when the decrypted certificate reveals that safety-relevant failures are indicated in the decrypted test results, the process is automatically terminated (step 228), and a charge transfer process cannot proceed between the two charging components. In some implementations, a user of the first charging component is informed (step 232) that the second charging component has failed one or more safety-relevant tests. In some implementations, the first charging component prompts (234) the user to decide whether to continue the charging process. In such cases, a user can still decide to continue the charge transfer process despite an indication that the second charging component has failed one or more safety-relevant tests. In some implementations, when the decrypted certificate reveals that performance-relevant failures are indicated in the decrypted test results, the process is automatically terminated (step 228), and a charge transfer process cannot proceed between the two charging components. In some implementations, a user of the first charging component is informed (step 242) that the second charging component has failed one or more performance-relevant tests. In some implementations, the first charging component prompts (244) the user to decide whether to continue the charging process. In such cases, a user can still decide to continue the charge transfer process despite an indication that the decrypted test results for the second charging component indicate one or more safety-relevant failures or performance-relevant failures, and the charge transfer process can proceed (step 250).

In the case where the decrypted certificate indicates that the second charging component has not failed any safety-relevant tests or any performance-relevant tests, the charge transfer process can proceed (step 250).

The first charging component (e.g., an EV) can determine whether to automatically (e.g., without user input, without additional user input, or without user intervention) terminate the charging process (step 228) or to request input from a user (e.g., to either continue or terminate the charging process) when the second charging component does not have a certificate or when the decrypted certificate indicates that the second charging component has failed one or more tests.

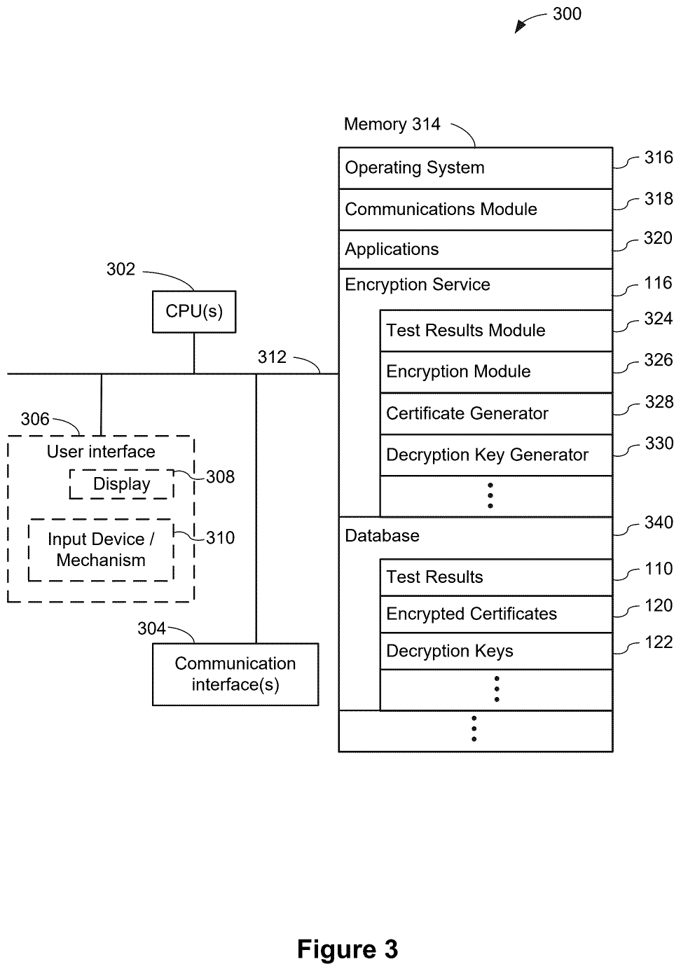

FIG. 3 is a block diagram of an example computing device 300 in accordance with some implementations. Various examples of the computing device 300 include a desktop computer, a laptop computer, a tablet computer, and other computing devices (e.g., IT or OT devices) that have a processor capable of providing (e.g., running) the encryption service. The computing device 300 typically includes one or more processing units/cores (CPUs) 302 for executing modules, programs, and/or instructions stored in the memory 314 and thereby performing processing operations; one or more network or other communications interfaces 304; memory 314; and one or more communication buses 312 for interconnecting these components. The communication buses 312 may include circuitry that interconnects and controls communications between system components.

The computing device 300 may be part of a network of computers or may be part of a server that provides the encryption service 116. The computing device 300 may correspond to a manufacturer of a charging component, a certification authority, or a third party that is trusted to perform the encryption for (e.g., on behalf of) the manufacturer or the certification authority.

In some implementations, the computing device 300 includes a user interface 306, which includes a display device 308 and one or more input devices or mechanisms 310. In some implementations, the input device/mechanism includes a keyboard. In some implementations, the input device/mechanism includes a “soft” keyboard, which is displayed as needed on the display device 308, enabling a user to “press keys” that appear on the display 308. In some implementations, the display 308 and input device/mechanism 310 comprise a touch screen display (also called a touch sensitive display).

In some implementations, the memory 314 includes high-speed random-access memory, such as DRAM, SRAM, DDR RAM or other random-access solid-state memory devices. In some implementations, the memory 314 includes non-volatile memory, such as one or more magnetic disk storage devices, optical disk storage devices, flash memory devices, or other non-volatile solid state storage devices. In some implementations, the memory 314 includes one or more storage devices remotely located from the CPU(s) 302. The memory 314, or alternatively the non-volatile memory device(s) within the memory 314, comprises a non-transitory computer-readable storage medium. In some implementations, the memory 314, or the computer-readable storage medium of the memory 314, stores the following programs, modules, and data structures, or a subset thereof:
an operating system 316, which includes procedures for handling various basic system services and for performing hardware dependent tasks;
a communications module 318, which is used for connecting the computing device 300 to other computers and devices via the one or more communication network interfaces 304 (wired or wireless) and one or more communication networks, such as the Internet, other wide area networks, local area networks, metropolitan area networks, and so on;
applications 320, which perform particular tasks or sets of tasks for a user (e.g., word processors, media players, web browsers, and communication platforms);
an encryption service 116, configured to generate encrypted certificates 120 and corresponding decryption keys 122 from test results 110. The encryption service 116 includes one or more of:
   a test results module 324, which receives and validates test results 110 from manufacturers for various charging components 102. Test results can be validated by, for example, comparing decrypted test results to ideal test result data (also referred to as reference test result data). The test results may include binary data or continuous values. For example, the test data may include values such as a fault response time, current ramp down time, current ramp up rate, voltage ramp rate, or a threshold isolation resistance value for shut off.
   an encryption module 326, which encrypts the test results 110;
   a certificate generator 328, which generates the encrypted certificates 120 using the encrypted test results; and
   a decryption key generator 330, which generates decryption keys 122 for decrypting encrypted certificates 120; and
one or more databases 340 (which may correspond to data storage 130 shown in FIG. 1), which are used by the applications 320 and/or the encryption service 116. The one or more databases 340 may include test results 110 for various charging components 102, as well as any encrypted certificates 120 and decryption keys 122 that were generated by the encryption service 116.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 314 stores a subset of the modules and data structures identified above. Furthermore, the memory 314 may store additional modules or data structures not described above.

Although FIG. 3 shows a computing device 300, FIG. 3 is intended more as a functional description of the various features that may be present rather than as a structural schematic of the implementations described herein. In practice, and as recognized by those of ordinary skill in the art, items shown separately could be combined and some items could be separated.

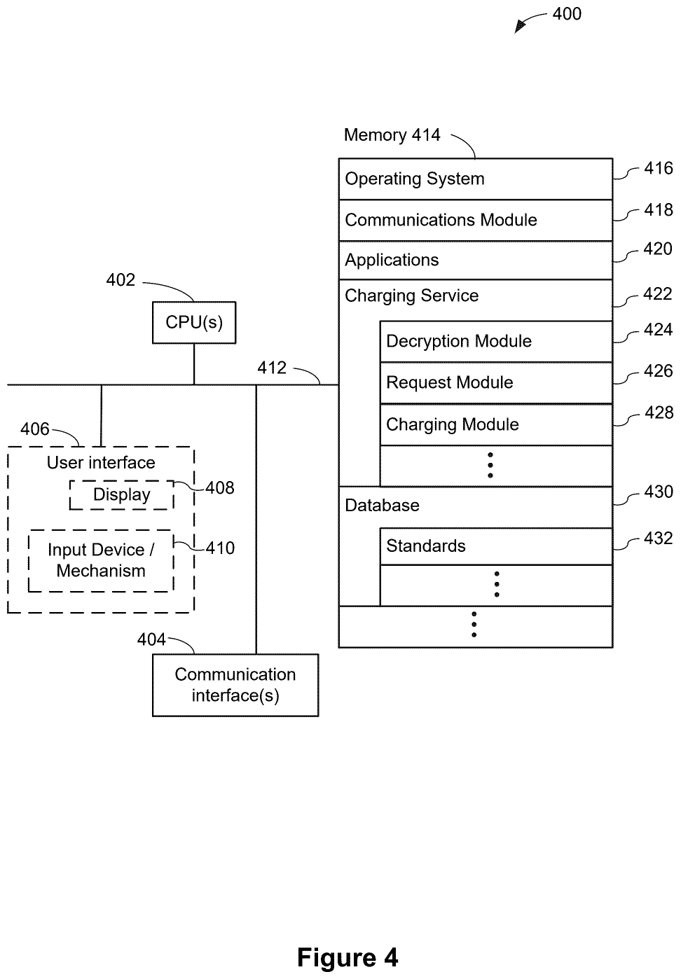

FIG. 4 is a block diagram of an example computing device 400 in accordance with some implementations. Various examples of the computing device 400 include computing devices (e.g., IT or OT devices) that have a processor capable of providing (e.g., running) a charging service. The computing device 400 typically includes one or more processing units/cores (CPUs) 402 for executing modules, programs, and/or instructions stored in the memory 414 and thereby performing processing operations; one or more network or other communications interfaces 404; memory 414; and one or more communication buses 412 for interconnecting these components. The communication buses 412 may include circuitry that interconnects and controls communications between system components.

The computing device 400 may be part of a charging component, such as an on-board computer on an EV, an integrated computer within a charging station, or a controller that is part of a charging accessory. The computing device 400 can correspond to any processing unit that is part of a charging component that is configured to receive charge, provide charge to an EV, or assist in charging an EV (e.g., a charging cable).

In some implementations, the computing device 400 includes a user interface 406, which includes a display device 408 and one or more input devices or mechanisms 410. In some implementations, the input device/mechanism includes a keyboard. In some implementations, the input device/mechanism includes a “soft” keyboard, which is displayed as needed on the display device 408, enabling a user to “press keys” that appear on the display 408. In some implementations, the display 408 and input device/mechanism 410 comprise a touch screen display (also called a touch sensitive display).

In some implementations, the memory 414 includes high-speed random-access memory, such as DRAM, SRAM, DDR RAM or other random-access solid-state memory devices. In some implementations, the memory 414 includes non-volatile memory, such as one or more magnetic disk storage devices, optical disk storage devices, flash memory devices, or other non-volatile solid state storage devices. In some implementations, the memory 414 includes one or more storage devices remotely located from the CPU(s) 402. The memory 414, or alternatively the non-volatile memory device(s) within the memory 414, comprises a non-transitory computer-readable storage medium. In some implementations, the memory 414, or the computer-readable storage medium of the memory 414, stores the following programs, modules, and data structures, or a subset thereof:
an operating system 416, which includes procedures for handling various basic system services and for performing hardware dependent tasks;
a communications module 418, which is used for connecting the computing device 400 to other computers and devices via the one or more communication network interfaces 404 (wired or wireless) and one or more communication networks, such as the Internet, other wide area networks, local area networks, metropolitan area networks, and so on;
applications 420, which perform particular tasks or sets of tasks for a user;
a charging service 422, configured to communicate with a charging partner (e.g., another charging component 102) and either provide, receive, or transmit charge. The charging service 422 includes one or more of:
   a decryption module 424, which decrypts encrypted certificates 120 for charging components 102 using a corresponding decryption key 122;
   a request module 426, which can send requests for encrypted certificates 120 and can provide an encrypted certificate 120 for a charging component 102 corresponding to the computing device 400 to a charging partner (e.g., another charging component 102) upon request; and
   a charging module 428, which performs the charge transfer process; and
one or more databases 430, which are used by the applications 420 and/or the charging module 428. The one or more databases 430 may include test results 110 for the charging component 102 corresponding to the computing device 400, as well as any encrypted certificates 120 and decryption keys 122 that were generated by the encryption service 116 for the charging component 102 corresponding to the computing device 400. For example, a charging component 102 corresponding to the computing device 400 may include one or more databases 430 that store an encrypted certificate 120 and decryption key 122 for the charging component 102. In such cases, the charging component 102 can share the encrypted certificate 120 and decryption key 122 with another charging component (e.g., a charging partner) upon request.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 414 stores a subset of the modules and data structures identified above. Furthermore, the memory 414 may store additional modules or data structures not described above.

Although FIG. 4 shows a computing device 400, FIG. 4 is intended more as a functional description of the various features that may be present rather than as a structural schematic of the implementations described herein. In practice, and as recognized by those of ordinary skill in the art, items shown separately could be combined and some items could be separated.

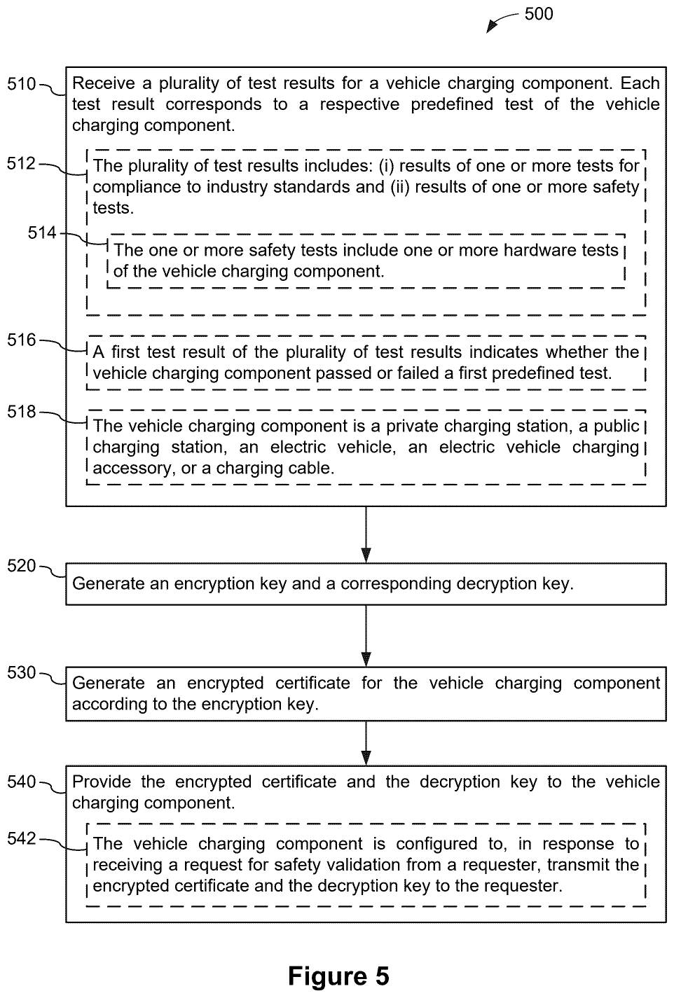

FIG. 5 provides a flowchart of a method 500 for generating an encrypted certificate and decryption key for authenticating vehicle charging equipment (similar to the process 100 shown in FIG. 1) in accordance with some implementations. The method 500 is performed at a computing system (e.g., the computing device 300 shown in FIG. 3, which provides the encryption service 116) having one or more processors and memory. In some implementations, the memory stores one or more programs configured for execution by the one or more processors. The method 500 includes receiving (step 510) a plurality of test results 110 for a vehicle charging component 102. Each test result corresponds to a respective predefined test of the vehicle charging component 102 (e.g., a test corresponding to one or more safety requirements, performance requirements, or standards). The method 500 also includes generating (step 520) an encryption key and a corresponding decryption key 122, generating (step 530) an encrypted certificate 120 for the vehicle charging component 102 according to the encryption key, and providing (step 540) the encrypted certificate 120 and the decryption key 122 to the vehicle charging component 102.

In some implementations, the plurality of test results 110 includes (step 512): (i) results of one or more tests for compliance to industry standards (e.g., international standards, country standards IEC 61851 (All parts), ISO 15118 (All parts), DIN 70121, SAE J1772, IEC 62196, UL 2231, 2232, 2251, and any standards that govern high voltage charging) and (ii) results of one or more safety tests (e.g., safety test results 110).

In some implementations, the one or more safety tests include (step 514) one or more hardware tests of the vehicle charging component.

In some implementations, a first test result of the plurality of test results indicates (step 516) whether the vehicle charging component 102 passed or failed a first predefined test.

In some implementations, the vehicle charging component 102 is (step 518) a private charging station, a public charging station, an electric vehicle, an electric vehicle charging accessory, or a charging cable.

In some implementations, the vehicle charging component 102 is configured to (step 542), in response to receiving a request for safety validation from a requester, transmit the encrypted certificate and the decryption key to the requester.

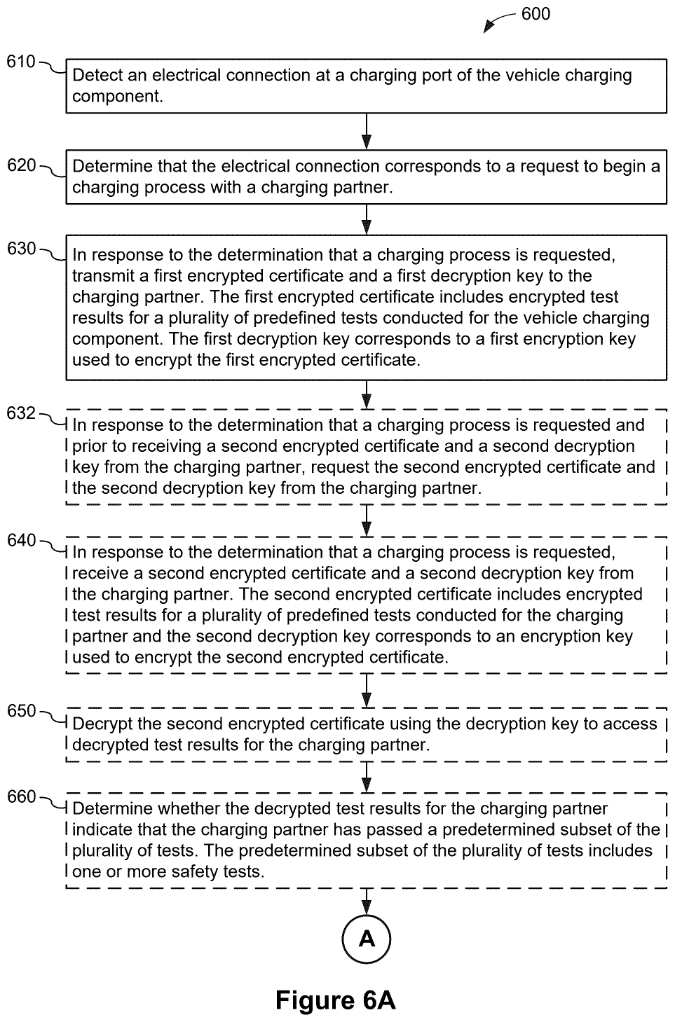

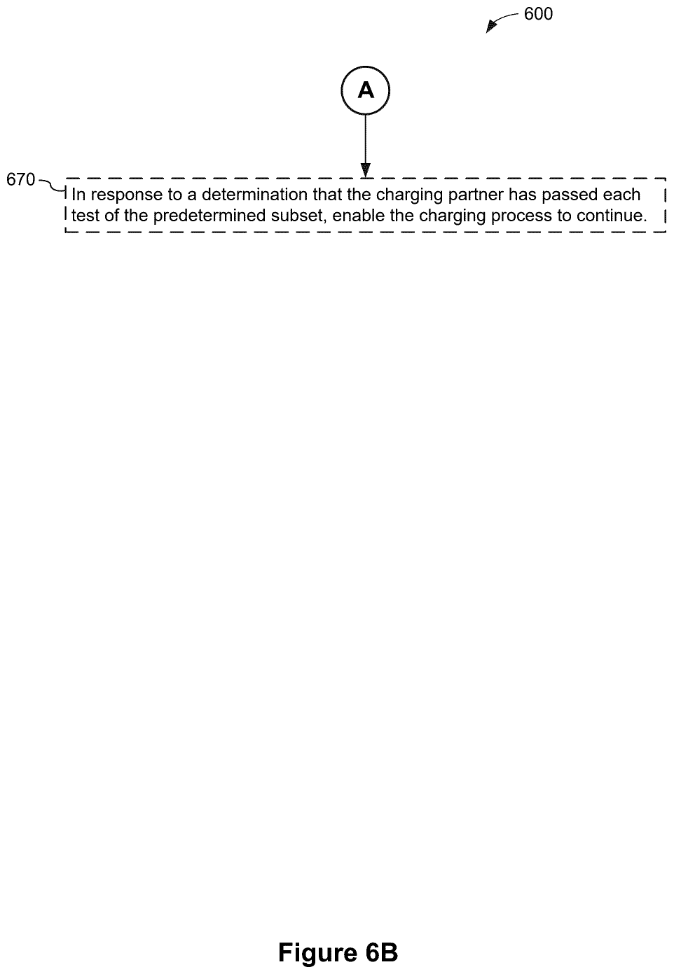

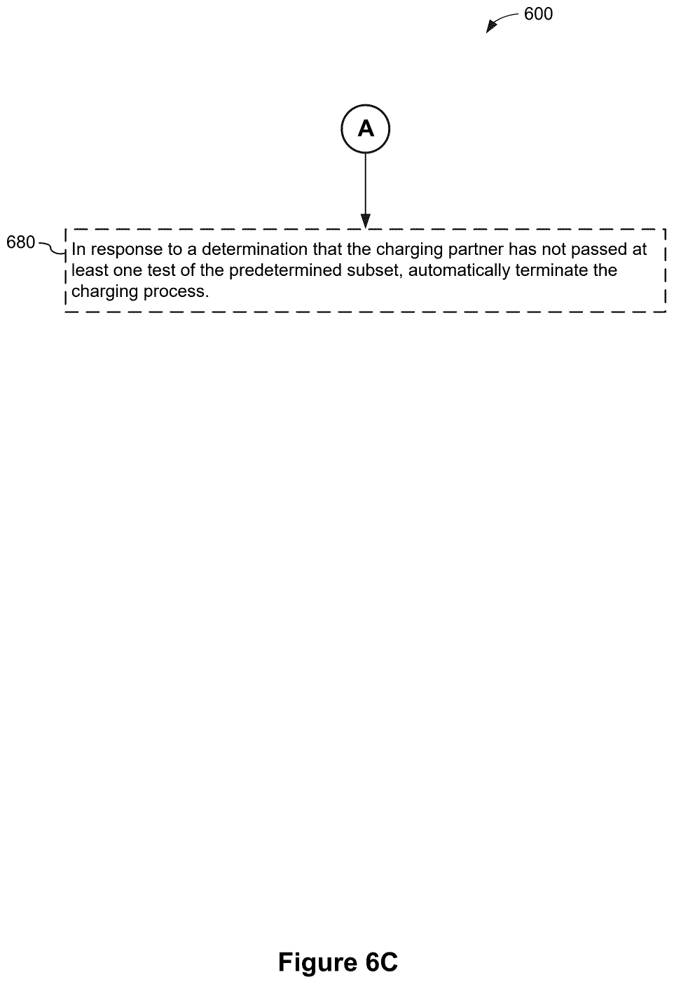

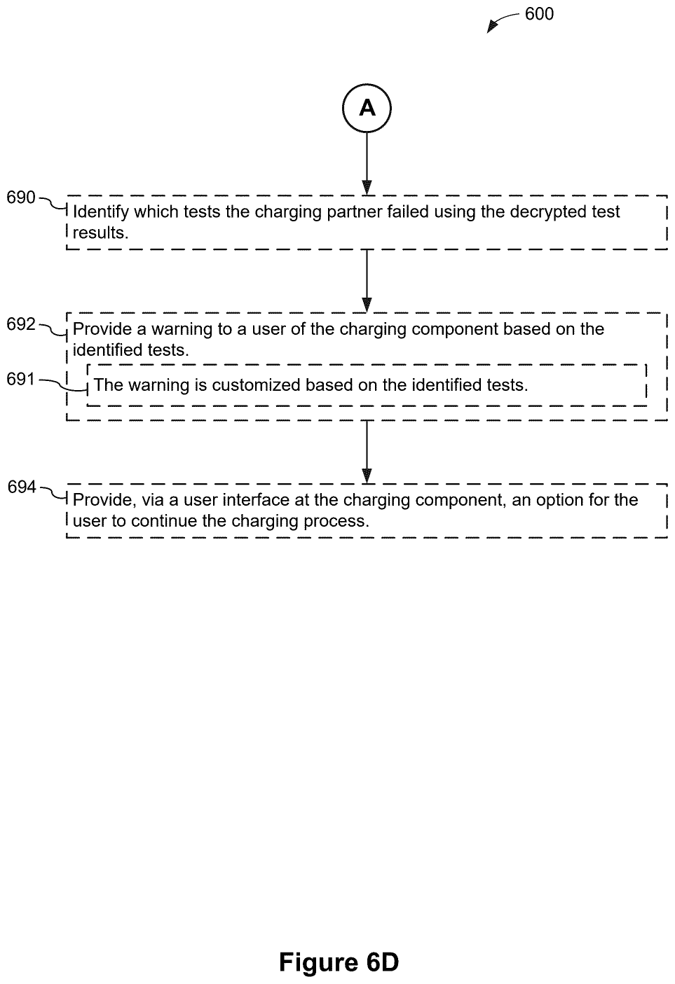

FIG. 6A-6D provide a flowchart of a method for authenticating vehicle charging equipment (similar to the process 200 shown in FIG. 2) in accordance with some implementations. The method 600 is performed at a computing system (e.g., the computing device 400 shown in FIG. 4, which provides the charging service 422) that is part of a charging component 102. The computing system has one or more processors and memory. In some implementations, the memory stores one or more programs configured for execution by the one or more processors. In some implementations, the method 600 includes detecting (step 610) an electrical connection at a charging port of the vehicle charging component 102 and determining (step 620) that the electrical connection corresponds to a request to begin a charging process with a charging partner (e.g., another charging component). The method 600 also includes, in response to the determination (step 620) that a charging process is requested, transmitting (step 630) a first encrypted certificate 120 and a first decryption key 122 to the charging partner. The first encrypted certificate 120 includes encrypted test results for a plurality of predefined tests conducted for the vehicle charging component 102. The first decryption key 122 corresponds to a first encryption key used to encrypt the first encrypted certificate 120.

In some implementations, the method 600 further includes, in response to the determination (step 620) that a charging process is requested and prior to receiving (step 640) a second encrypted certificate and a second decryption key from the charging partner, requesting (step 632) the second encrypted certificate and the second decryption key from the charging partner.

In some implementations, the method 600 also includes, in response to the determination (step 620) that a charging process is requested, receiving (step 640) a second encrypted certificate and a second decryption key from the charging partner. The second encrypted certificate includes encrypted test results for a plurality of predefined tests conducted for the charging partner and the second decryption key corresponds to an encryption key used to encrypt the second encrypted certificate. The method 600 also includes decrypting (step 650) the second encrypted certificate using the decryption key to access decrypted test results for the charging partner and determining (step 660) whether the decrypted test results for the charging partner indicate that the charging partner has passed a predetermined subset of the plurality of tests. The predetermined subset of the plurality of tests includes one or more safety tests.

In some implementations, the method 600 further includes, in response to a determination that the charging partner has passed each test of the predetermined subset, enabling (step 670) the charging process to continue.

In some implementations, the method 600 also includes, in response to a determination that the charging partner has not passed at least one test of the predetermined subset, automatically terminating (step 680) the charging process.

In some implementations, the method 600 further includes identifying (step 690) which tests the charging partner failed using the decrypted test results and providing (step 692) a warning to a user of the charging component 102 based on the identified tests.

In some implementations, the warning is customized (step 691) based on the identified tests. For example, the warning may include a yellow alert indicating that the charging partner failed one or more performance tests and passed all safety tests. In another example, the warning may include a red alert indicating that the charging partner failed one or more safety tests. In yet another example, the warning may include a “high level” alert indicating that the charging partner does not have an encrypted certificate and thus, cannot be trusted.

In some implementations, the method 600 further includes, providing (step 694), via a user interface at the charging component, an option for the user to continue the charging process. For example, the charging component 102 may provide an option for the user to disregard (e.g., dismiss) the warning and continue the charging process.

Turning now to some example implementations.
(A1) In one aspect, some implementations include a method for receiving a plurality of test results for a vehicle charging component, where each test result corresponds to a respective predefined test of the vehicle charging component. The method also includes generating an encryption key and a corresponding decryption key, generating an encrypted certificate for the vehicle charging component according to the encryption key, and providing the encrypted certificate and the decryption key to the vehicle charging component.
(A2) The method of A1, where the plurality of test results includes: (i) results of one or more tests for compliance to industry standards and (ii) results of one or more safety tests.
(A3) The method of A2, where the one or more safety tests include one or more hardware tests of the vehicle charging component.
(A4) The method of any of A1-A3, where a first test result of the plurality of test results indicates whether the vehicle charging component passed or failed a first predefined test.
(A5) The method of any of A1-A4, where the vehicle charging component is a private charging station, a public charging station, an electric vehicle, an electric vehicle charging accessory, or a charging cable.
(A6) The method of any of A1-A5, where the vehicle charging component is configured to, in response to receiving a request for safety validation from a requester, transmit the encrypted certificate and the decryption key to the requester.
(B1) In another aspect, a computing device includes one or more processors, memory, and one or more programs stored in the memory and configured for execution by the one or more processors. The one or more programs include instructions for receiving a plurality of test results for a vehicle charging component, where each test result corresponds to a respective predefined test of the vehicle charging component. The one or more programs also include instructions for generating an encryption key and a corresponding decryption key, generating an encrypted certificate for the vehicle charging component according to the encryption key, and providing the encrypted certificate and the decryption key to the vehicle charging component.
(B2) The computing device of B1, where the plurality of test results includes: (i) results of one or more tests for compliance to industry standards and (ii) results of one or more safety tests.
(B3) The computing device of B2, where the one or more safety tests include one or more hardware tests of the vehicle charging component.
(B4) The computing device of any of B1-B3, where a first test result of the plurality of test results indicates whether the vehicle charging component passed or failed a first predefined test.
(B5) The computing device of any of B1-B4, where the vehicle charging component is a private charging station, a public charging station, an electric vehicle, an electric vehicle charging accessory, or a charging cable.
(B6) The computing device of any of B1-B5, where the vehicle charging component is configured to, in response to receiving a request for safety validation from a requester, transmit the encrypted certificate and the decryption key to the requester.
(C1) A non-transitory computer-readable storage medium stores one or more programs configured for execution by a computing device that has one or more processors and memory. The one or more programs including instructions for receiving a plurality of test results for a vehicle charging component, where each test result corresponds to a respective predefined test of the vehicle charging component. The instructions further include generating an encryption key and a corresponding decryption key, generating an encrypted certificate for the vehicle charging component according to the encryption key, and providing the encrypted certificate and the decryption key to the vehicle charging component.
(C2) A non-transitory computer-readable storage medium of C1, where the plurality of test results includes: (i) results of one or more tests for compliance to industry standards and (ii) results of one or more safety tests.
(C3) A non-transitory computer-readable storage medium of C2, where the one or more safety tests include one or more hardware tests of the vehicle charging component.
(C4) A non-transitory computer-readable storage medium of any of C1-C3, where a first test result of the plurality of test results indicates whether the vehicle charging component passed or failed a first predefined test.
(C5) A non-transitory computer-readable storage medium of any of C1-C4, where the vehicle charging component is a private charging station, a public charging station, an electric vehicle, an electric vehicle charging accessory, or a charging cable.
(C6) A non-transitory computer-readable storage medium of any of C1-C5, where the vehicle charging component is configured to, in response to receiving a request for safety validation from a requester, transmit the encrypted certificate and the decryption key to the requester.
(D1) A method performed at a vehicle charging component includes detecting an electrical connection at a charging port of the vehicle charging component, determining that the electrical connection corresponds to a request to begin a charging process with a charging partner, and in response to the determination that a charging process is requested, transmitting a first encrypted certificate and a first decryption key to the charging partner. The first encrypted certificate includes encrypted test results for a plurality of tests conducted for the vehicle charging component and the first decryption key corresponds to a first encryption key used to encrypt the first encrypted certificate.
(D2) The method of D1, further including, in response to the determination that a charging process is requested, receiving a second encrypted certificate and a second decryption key from the charging partner. The second encrypted certificate includes encrypted test results for a plurality of tests conducted for the charging partner, and the second decryption key corresponds to an encryption key used to encrypt the second encrypted certificate. The method also includes decrypting the second encrypted certificate using the decryption key to access decrypted test results for the charging partner and determining whether the decrypted test results for the charging partner indicate that the charging partner has passed a predetermined subset of the plurality of tests. The predetermined subset of the plurality of tests includes one or more safety tests. The method further includes, in response to a determination that the charging partner has passed each test of the predetermined subset, enabling the charging process to continue.
(D3) The method of D2, further including, in response to the determination that a charging process is requested and prior to receiving the second encrypted certificate and the second decryption key from the charging partner, requesting the second encrypted certificate and the second decryption key from the charging partner.
(D4) The method of D2 or D3, further including, in response to a determination that the charging partner has not passed at least one test of the predetermined subset, automatically terminating the charging process.
(D5) The method of D2 or D3, further including identifying which tests the charging partner failed using the decrypted test results and providing a warning to a user of the charging component based on the identified tests.
(D6) The method of D5, where the warning is customized based on the identified tests.
(D7) The method of D5 or D6, further including providing, via a user interface at the charging component, an option for the user to continue the charging process
(D8) The method of any of D2-D7, where the charging partner is configured to receive and/or transmit electrical charge and the charging partner is an electric vehicle, a charging station, an electric vehicle charging accessory, or a charging cable.
(D9) The method of any of D1-D8, where the vehicle charging component is configured to receive and/or transmit electrical charge and the vehicle charging component is a private charging station, a public charging station, an electric vehicle, or an electric vehicle charging accessory.
(E1) A computing device that is part of a vehicle charging component, the computing device including one or more processors, memory, and one or more programs stored in the memory and configured for execution by the one or more processors. The one or more programs comprise instructions for detecting an electrical connection at a charging port of the vehicle charging component and determining that the electrical connection corresponds to a request to begin a charging process with a charging partner. In response to the determination that a charging process is requested, the instructions are further configured to transmit a first encrypted certificate and a first decryption key to the charging partner. The first encrypted certificate includes encrypted test results for a plurality of tests conducted for the vehicle charging component and the first decryption key corresponds to a first encryption key used to encrypt the first encrypted certificate.
(E2) The computing device of E1, where the instructions are further configured to, in response to the determination that a charging process is requested, receive a second encrypted certificate and a second decryption key from the charging partner. The second encrypted certificate includes encrypted test results for a plurality of tests conducted for the charging partner, and the second decryption key corresponds to an encryption key used to encrypt the second encrypted certificate. The instructions are further configured to decrypt the second encrypted certificate using the decryption key to access decrypted test results for the charging partner and to determine whether the decrypted test results for the charging partner indicate that the charging partner has passed a predetermined subset of the plurality of tests. The predetermined subset of the plurality of tests includes one or more safety tests. The instructions are further configured to, in response to a determination that the charging partner has passed each test of the predetermined subset, enable the charging process to continue.
(E3) The computing device of E2, where the instructions are further configured to, in response to the determination that a charging process is requested and prior to receiving the second encrypted certificate and the second decryption key from the charging partner, request the second encrypted certificate and the second decryption key from the charging partner.
(E4) The computing device of E2 or E3, where the instructions are further configured to, in response to a determination that the charging partner has not passed at least one test of the predetermined subset, automatically terminate the charging process.
(E5) The computing device of E2 or E3, where the instructions are further configured to identify which tests the charging partner failed using the decrypted test results and provide a warning to a user of the charging component based on the identified tests.
(E6) The computing device of E5, where the warning is customized based on the identified tests.
(E7) The computing device of E5 or E6, where the instructions are further configured to provide, via a user interface at the charging component, an option for the user to continue the charging process
(E8) The computing device of any of E2-E7, where the charging partner is configured to receive and/or transmit electrical charge and the charging partner is an electric vehicle, a charging station, an electric vehicle charging accessory, or a charging cable.
(E9) The computing device of any of E1-E8, where the vehicle charging component is configured to receive and/or transmit electrical charge and the vehicle charging component is a private charging station, a public charging station, an electric vehicle, or an electric vehicle charging accessory.
(F1) A non-transitory computer-readable storage medium stores one or more programs configured for execution by a computing device that is part of a vehicle charging component. The computing device has one or more processors and memory, and the one or more programs comprise instructions for: (i) detecting an electrical connection at a charging port of the vehicle charging component, (ii) determining that the electrical connection corresponds to a request to begin a charging process with a charging partner, and (iii) in response to the determination that a charging process is requested, transmitting a first encrypted certificate and a first decryption key to the charging partner. The first encrypted certificate includes encrypted test results for a plurality of tests conducted for the vehicle charging component and the first decryption key corresponds to a first encryption key used to encrypt the first encrypted certificate.
(F2) The non-transitory computer-readable storage medium of F1, where the instructions are further configured to, in response to the determination that a charging process is requested, receive a second encrypted certificate and a second decryption key from the charging partner. The second encrypted certificate includes encrypted test results for a plurality of tests conducted for the charging partner, and the second decryption key corresponds to an encryption key used to encrypt the second encrypted certificate. The instructions are further configured to decrypt the second encrypted certificate using the decryption key to access decrypted test results for the charging partner and determine whether the decrypted test results for the charging partner indicate that the charging partner has passed a predetermined subset of the plurality of tests. The predetermined subset of the plurality of tests includes one or more safety tests. The instructions are further configured to, in response to a determination that the charging partner has passed each test of the predetermined subset, enable the charging process to continue.
(F3) The non-transitory computer-readable storage medium of F2, where the instructions are further configured to, in response to the determination that a charging process is requested and prior to receiving the second encrypted certificate and the second decryption key from the charging partner, request the second encrypted certificate and the second decryption key from the charging partner.
(F4) The non-transitory computer-readable storage medium of F2 or F3, where the instructions are further configured to, in response to a determination that the charging partner has not passed at least one test of the predetermined subset, automatically terminate the charging process.
(F5) The non-transitory computer-readable storage medium of F2 or F3, where the instructions are further configured to identify which tests the charging partner failed using the decrypted test results and provide a warning to a user of the charging component based on the identified tests.
(F6) The non-transitory computer-readable storage medium of F5, where the warning is customized based on the identified tests.
(F7) The non-transitory computer-readable storage medium of F5 or F6, where the instructions further include providing, via a user interface at the charging component, an option for the user to continue the charging process
(F8) The non-transitory computer-readable storage medium of any of F2-F7, where the charging partner is configured to receive and/or transmit electrical charge and the charging partner is an electric vehicle, a charging station, an electric vehicle charging accessory, or a charging cable.
(F9) The non-transitory computer-readable storage medium of any of F1-F8, where the vehicle charging component is configured to receive and/or transmit electrical charge and the vehicle charging component is a private charging station, a public charging station, an electric vehicle, or an electric vehicle charging accessory.
(G1) A vehicle includes a charging port configured to couple with a charging accessory for exchange of electrical charge with a charging partner and a non-transitory computer-readable storage medium configured to store an encrypted certificate and a decryption key corresponding to an encryption key used to encrypt the encrypted certificate. The encrypted certificate includes a plurality of encrypted test results for a plurality of tests conducted on a vehicle charging component and a first test result of the plurality of encrypted test results indicates whether the charging component passed or failed a first predefined test.
(G2) The vehicle of G1, where the vehicle charging component is configured to, in response to receiving a request for safety validation from the charging partner, transmit the encrypted certificate and the decryption key to the charging partner.
(G3) The vehicle of G1 or G2, where the vehicle charging component is a private charging station, a public charging station, an electric vehicle, or an electric vehicle charging accessory.
(G4) The vehicle of any of G1-G3, where the vehicle charging component is configured to receive and/or transmit electrical charge.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

What is claimed is:

1. A method, comprising:
receiving a plurality of test results for a vehicle charging component, each test result corresponding to a respective predefined test of the vehicle charging component;
generating an encryption key and a corresponding decryption key;
generating an encrypted certificate for the vehicle charging component according to the encryption key; and
providing the encrypted certificate and the decryption key to the vehicle charging component.

2. The method of claim 1, wherein the plurality of test results includes: (i) results of one or more tests for compliance to industry standards and (ii) results of one or more safety tests.

3. The method of claim 2, wherein the one or more safety tests include one or more hardware tests of the vehicle charging component.

4. The method of claim 1, wherein a first test result of the plurality of test results indicates whether the vehicle charging component passed or failed a first predefined test.

5. The method of claim 1, wherein the vehicle charging component is a private charging station, a public charging station, an electric vehicle, or an electric vehicle charging accessory.

6. The method of claim 1, wherein the vehicle charging component is a charging cable.

7. The method of claim 1, wherein the vehicle charging component is configured to, in response to receiving a request for safety validation from a requester, transmit the encrypted certificate and the decryption key to the requester.

8. A computing device, comprising:
one or more processors;
memory; and
one or more programs stored in the memory and configured for execution by the one or more processors, the one or more programs comprising instructions for:
receiving a plurality of test results for a vehicle charging component, each test result corresponding to a respective predefined test of the vehicle charging component;
generating an encryption key and a corresponding decryption key;
generating an encrypted certificate for the vehicle charging component according to the encryption key; and
providing the encrypted certificate and the decryption key to the vehicle charging component.

9. The computing device of claim 8, wherein the plurality of test results includes: (i) results of one or more tests for compliance to industry standards and (ii) results of one or more safety tests.

10. The computing device of claim 9, wherein the one or more safety tests include one or more hardware tests of the vehicle charging component.

11. The computing device of claim 8, wherein a first test result of the plurality of test results indicates whether the vehicle charging component passed or failed a first predefined test.

12. The computing device of claim 8, wherein the vehicle charging component is a private charging station, a public charging station, an electric vehicle, an electric vehicle charging accessory, or a charging cable.

13. The computing device of claim 8, the vehicle charging component is configured to, in response to receiving a request for safety validation from a requester, transmit the encrypted certificate and the decryption key to the requester.

14. A non-transitory computer-readable storage medium storing one or more programs configured for execution by a computing device having one or more processors and memory, the one or more programs comprising instructions for:
receiving a plurality of test results for a vehicle charging component, each test result corresponding to a respective predefined test of the vehicle charging component;
generating an encryption key and a corresponding decryption key;
generating an encrypted certificate for the vehicle charging component according to the encryption key; and
providing the encrypted certificate and the decryption key to the vehicle charging component.

15. The non-transitory computer-readable storage medium of claim 14, wherein the plurality of test results includes: (i) results of one or more tests for compliance to industry standards and (ii) results of one or more safety tests.

16. The non-transitory computer-readable storage medium of claim 15, wherein the one or more safety tests include one or more hardware tests of the vehicle charging component.

17. The non-transitory computer-readable storage medium of claim 14, wherein a first test result of the plurality of test results indicates whether the vehicle charging component passed or failed a first predefined test.

18. The non-transitory computer-readable storage medium of claim 14, wherein the vehicle charging component is a private charging station, a public charging station, an electric vehicle, an electric vehicle charging accessory, or a charging cable.

19. The non-transitory computer-readable storage medium of claim 14, wherein the vehicle charging component is configured to, in response to receiving a request for safety validation from a requester, transmit the encrypted certificate and the decryption key to the requester.
